(19) United States
(12) Patent Application Publication
(10) Pub. No.: US 2016/0359194 A1
(43) Pub. Date: Dec. 8, 2016

(54) SOLID ELECTROLYTE COMPOSITION, METHOD FOR MANUFACTURING THE SAME, AND ELECTRODE SHEET FOR BATTERY AND ALL-SOLID-STATE SECONDARY BATTERY IN WHICH SOLID ELECTROLYTE COMPOSITION IS USED

(71) Applicant: FUJIFILM Corporation, Tokyo (JP)

(72) Inventors: Katsuhiko MEGURO, Ashigarakami-gun (JP); Hiroaki MOCHIZUKI, Ashigarakami-gun (JP); Masaomi MAKINO, Ashigarakami-gun (JP); Tomonori MIMURA, Ashigarakami-gun (JP)

(73) Assignee: FUJIFILM Corporation, Tokyo (JP)

(21) Appl. No.: 15/243,155

(22) Filed: Aug. 22, 2016

Related U.S. Application Data
(63) Continuation of application No. PCT/JP2015/054368, filed on Feb. 18, 2015.

(30) Foreign Application Priority Data
Feb. 24, 2014 (JP) 2014-033286

(51) Int. Cl. H01M 10/0562; H01M 10/0585; H01M 10/0525

(52) U.S. Cl. CPC H01M 10/0562; H01M 10/0525; H01M 10/0585

(57) ABSTRACT

Provided is a solid electrolyte composition including inorganic solid electrolyte particles exhibiting at least two peaks in accumulative particle size distribution which is measured with a dynamic light scattering-type particle diameter distribution measuring device.

### CROSS-REFERENCE TO RELATED APPLICATIONS

This application is a Continuation of PCT International Application No. PCT/JP2015/054368 filed on Feb. 18, 2015, which claims priority under 35 U.S.C. §119 (a) to Japanese Patent Application No. JP2014-033286 filed in Japan on Feb. 24, 2014.

Each of the above applications is hereby expressly incorporated by reference, in its entirety, into the present application.

### BACKGROUND OF THE INVENTION

1. Field of the Invention

The present invention relates to a solid electrolyte composition, a method for manufacturing the same, and an electrode sheet for a battery and an all-solid-state secondary battery in which the solid electrolyte composition is used.

2. Description of the Related Art

An electrolyte solution is used in a lithium ion battery which is widely used currently in many cases. There has been an attempt to cause all configuration materials to be solid by substituting the electrolyte solution with a solid electrolyte. Above all, the advantages of the technique of using an inorganic solid electrolyte are reliability at the time of usage and stability. A combustible material such as a carbonate-based solvent is applied as a medium of the electrolyte solution which is used in the lithium ion secondary battery. Various measures are employed, but an additional measurement to be performed when a battery is overcharged is desired. An all-solid-state secondary battery formed of an inorganic compound that can cause an electrolyte to be incombustible is regarded as fundamental solving means thereof.

Another advantage of the all-solid-state secondary battery is that a high energy density is suitably achieved by stacking electrodes. Specifically, the all-solid-state secondary battery can be a battery having a structure in which electrodes and electrolytes are directly arranged side by side to be serialized. At this point, a metal package that seals battery cells and a copper wire or a bus bar that connects battery cells can be omitted, and thus an energy density of the battery can be greatly increased. It is advantageous that compatibility with a positive electrode material in which a potential can be enhanced to a high level is good.

According to the respective advantages as described above, the development of the all-solid-state secondary battery as a next-generation lithium ion secondary battery is vigorously advanced (see NEDO: New Energy and Industrial Technology Development Organization, Fuel Cells-Hydrogen Technology Development Field, Electricity Storage Technology Development Division “NEDO 2008 Roadmap for the Development of Next Generation Automotive Battery Technology” (June 2009)). In the all-solid-state secondary battery, an inorganic solid electrolyte layer is particularly a member that does not exist in a liquid-type battery or a polymer-type battery, and the development thereof is emphasized. This solid electrolyte layer is generally formed by heating and pressurizing an electrolyte material applied thereto together with a binder. Accordingly, the adhesion state between the solid electrolyte layers is replaced from a point contact to a surface contact, particle boundary resistance is decreased, and impedance is decreased. A forming example of an all-solid-state lithium battery to which this step is employed is known (see JP3198828B). There is an example in which an average particle diameter (number average particle diameter) of the solid electrolyte particles thereof or the distribution thereof is caused to have a specific scope (see WO2011/105574A). Accordingly, it is considered that a slurry composition having favorable dispersibility and coatability can be obtained.

### SUMMARY OF THE INVENTION

According to the technique disclosed in WO2011/105574A, suitability of manufacturing may be improved as described above. However, if recently increasing demand on high performances required in the all-solid-state secondary battery is considered, development of techniques that can satisfy higher levels is required.

Therefore, the invention has an object of providing a solid electrolyte composition that can realize improved ion conductivity in an all-solid-state secondary battery and a method for manufacturing the same, and an electrode sheet for a battery and an all-solid-state secondary battery in which the solid electrolyte composition is used.

The problems are solved by the means below.

[1] A solid electrolyte composition comprising: inorganic solid electrolyte particles exhibiting at least two peaks in accumulative particle size distribution which is measured with a dynamic light scattering-type particle diameter distribution measuring device.

[2] The solid electrolyte composition according to 1, in which, among the two or more peaks, a peak (Pa) of a maximum particle diameter is in the particle diameter range of 2 μm to 0.4 μm and a peak (Pb) of a minimum particle diameter is in the range of 1.5 μm to 0.1 μm, and a relationship between the peak (Pa) of the maximum particle diameter and the peak (Pb) of the minimum particle diameter satisfies Expression (1) below.

0.05≦Pb/Pa≦0.75 (1)

[3] The solid electrolyte composition according to 1 or 2, in which the inorganic solid electrolyte particles include inorganic solid electrolyte particles A having an average particle diameter (da) of 2 μm to 0.4 μm and inorganic solid electrolyte particles B having an average particle diameter (db) of 1.5 μm to 0.1 μm, and Expression (2) below is satisfied.

0.05≦db/da≦0.75 (2)

[4] The solid electrolyte composition according to any one of 1 to 3, in which, with respect to the accumulative particle size distribution measured with the dynamic light scattering-type particle diameter distribution measuring device, when respective peaks are assumed to follow log-normal distribution and the waveform is separated by a nonlinear least square method, an accumulative 90% particle diameter (Pa90) of a peak (Pa) of a maximum particle diameter is 3.4 μm to 0.7 μm, and an accumulative 90% particle diameter (Pb90) of a peak (Pb) of a minimum particle diameter is 2.5 μm to 0.2 μm.

[5] The solid electrolyte composition according to any one of 1 to 4, in which, with respect to the accumulative particle size distribution measured with the dynamic light scattering-type particle diameter distribution measuring device, when respective peaks are assumed to follow log-normal distribution and the waveform is separated by a nonlinear least square method, a ratio of an area (WPa) of a peak (Pa) of a maximum particle diameter and an area (WPb) of a peak (Pb) of a minimum particle diameter satisfies Expression (3) below.

0.01≦WPb/(WPa+WPb)≦0.8 (3)

[6] The solid electrolyte composition according to 3 or 4, in which an addition amount (Wb) of the inorganic solid electrolyte particles B is smaller than an addition amount (Wa) of the inorganic solid electrolyte particles A, and a mass ratio thereof satisfies Expression (4) below.

0.01≦Wb/(Wa+Wb)≦0.8 (4)

[7] The solid electrolyte composition according to any one of 1 to 6, in which the inorganic solid electrolyte is oxide-based or a sulfide-based inorganic solid electrolyte.

[8] The solid electrolyte composition according to any one of 1 to 7, further comprising: a binder.

[9] The solid electrolyte composition according to any one of 1 to 8, further comprising: a dispersion medium.

[10] A method for manufacturing a solid electrolyte composition prepared by mixing inorganic solid electrolyte particles A and inorganic solid electrolyte particles B,

in which the inorganic solid electrolyte particles A have an average particle diameter (da) of 2 μm to 0.4 μm,

in which the inorganic solid electrolyte particles B have an average particle diameter (db) of 1.5 μm to 0.1 μm, and

in which Expression (2) below is satisfied.

0.05≦db/da≦0.75 (2)

[11] The method for manufacturing the solid electrolyte composition according to 10, in which the inorganic solid electrolyte particles A have an accumulative 90% particle diameter of 3.4 μm to 0.7 μm, and in which the inorganic solid electrolyte particles B have an accumulative 90% particle diameter of 2.5 μm to 0.2 μm.

[12] The method for manufacturing the solid electrolyte composition according to 10 or 11, in which an addition amount (Wa) of the inorganic solid electrolyte particles A and an addition amount (Wb) of the inorganic solid electrolyte particles B satisfy Expression (4) below.

0.01≦Wb/(Wa+Wb)≦0.8 (4)

[13] The method for manufacturing the solid electrolyte composition according to any one of 10 to 12, in which the inorganic solid electrolyte particles A and the inorganic solid electrolyte particles B are treated at least by a wet dispersion method or a dry dispersion method, respectively, and the inorganic solid electrolyte particles A and the inorganic solid electrolyte particles B are mixed.

[14] An electrode sheet for a battery comprising: the solid electrolyte composition according to any one of 1 to 9.

[15] An all-solid-state secondary battery comprising: the electrode sheet for a battery according to 14.

The solid electrolyte composition according to the invention exhibits an excellent effect of realizing improved ion conductance when being used as materials of the inorganic solid electrolyte layer or the active substance layer of the all-solid-state secondary battery.

The electrode sheet for a battery and the all-solid-state secondary battery according to the invention include the solid electrolyte composition and exhibit the favorable performances above. In the manufacturing method according to the invention, the solid electrolyte composition and the all-solid-state secondary battery can be appropriately manufactured.

Aforementioned and additional features and advantages are clearly presented from the following descriptions suitably referring to the accompanying drawings.

### BRIEF DESCRIPTION OF THE DRAWINGS

FIG. 1 is a cross-sectional view schematically illustrating an all-solid-state lithium ion secondary battery according to a preferred embodiment of the invention.

FIGS. 2A to 2C are graphs illustrating particle size distribution of inorganic solid electrolyte particles.

### DESCRIPTION OF THE PREFERRED EMBODIMENTS

The solid electrolyte composition according to the invention includes particles of an inorganic solid electrolyte having particle size distribution. Hereinafter, preferred embodiments thereof are described, but, first, an example of the all-solid-state secondary battery which is a preferred application is described.

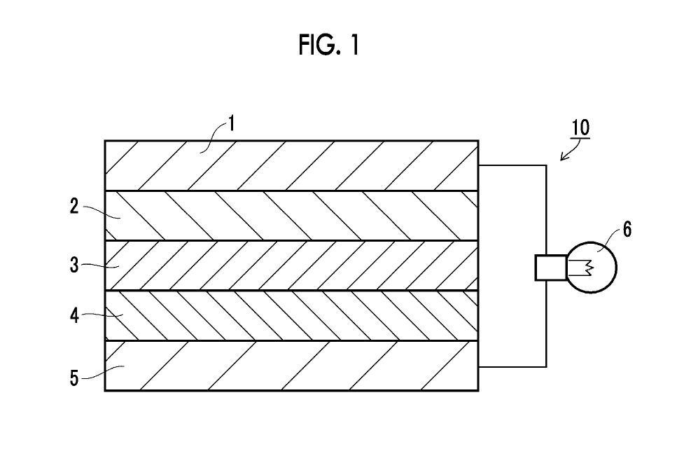

FIG. 1 is a sectional view schematically illustrating an all-solid-state secondary battery (lithium ion secondary battery) according to a preferred embodiment of the invention. An all-solid-state secondary battery 10 according to the embodiment includes a negative electrode collector 1, a negative electrode active substance layer 2, an inorganic solid electrolyte layer 3, a positive electrode active substance layer 4, and a positive electrode collector 5, in this sequence, from the negative electrode side. The respective layers are in contact with each other, and form a stacked structure. If this structure is applied, when the battery is charged, electrons (e) are supplied to a negative electrode side and lithium ions (Li⁺) are accumulated thereto. Meanwhile, when the battery is discharged, the lithium ions (Li⁺) accumulated in the negative electrode are returned to the positive electrode side, and electrons are supplied to an operating position 6. In the illustrated example, a bulb is employed in the operating position 6, and the bulb is turned on by the discharge. The solid electrolyte composition according to the invention is preferably used as a configuration material of the negative electrode active substance layer, the positive electrode active substance layer, and the inorganic solid electrolyte layer. Among them, the inorganic solid electrolyte composition according to the invention is preferably used as a configuration material of all of the inorganic solid electrolyte layer, the positive electrode active substance layer, and the negative electrode active substance layer.

Thicknesses of the positive electrode active substance layer 4, the inorganic solid electrolyte layer 3, and the negative electrode active substance layer 2 are not particularly limited, but the thicknesses of the positive electrode active substance layer and the negative electrode active substance layer can be arbitrarily measured according to a desired capacity of a battery. Meanwhile, the inorganic solid electrolyte layer is desirably thinned as possible, while preventing a short circuit of positive and negative electrodes. Specifically, the thickness is preferably 1 μm to 1,000 m and more preferably 3 μm to 400 μm.

Multifunctional layers may be appropriately inserted or disposed between respective layers of the negative electrode collector 1, the negative electrode active substance layer 2, the inorganic solid electrolyte layer 3, the positive electrode active substance layer 4, and the positive electrode collector 5 or on the outside thereof. In addition, the respective layers may be formed with a single layer or may be formed with multiple layers.

<Solid Electrolyte Composition>

(Inorganic Solid Electrolyte)

The inorganic solid electrolyte is an inorganic solid electrolyte, and the solid electrolyte is a solid-state electrolyte that can enables ions to move inside thereof. In this point of view, the inorganic solid electrolyte may be referred to as an ion conductive inorganic solid electrolyte, in order to differentiate the inorganic solid electrolyte with an electrolyte salt (supporting electrolyte) described below.

Since the inorganic solid electrolyte does not include an organic matter, that is, a carbon atom, the inorganic solid electrolyte is clearly differentiated from an organic solid electrolyte (a high polymer electrolyte represented by PEO and the like and an organic electrolyte salt represented by LiTFSI and the like).

In addition, the inorganic solid electrolyte is solid in a normal state, and thus is not dissociated or isolated into cations or anions. In this point of view, the inorganic solid electrolyte is clearly differentiated from an inorganic electrolyte salt (LiPF₆, LiBF₄, LiFSI, LiCl, and the like) which is dissociated or isolated into cations or anions in an electrolyte solution or a polymer. The inorganic solid electrolyte is not particularly limited, as long as the inorganic solid electrolyte has conductivity of an ion of metal belonging to Group 1 or 2 in the periodic table and generally does not have electron conductivity.

According to the invention, the solid electrolyte composition contains the inorganic solid electrolyte. Among these, it is preferable that the solid electrolyte composition is an ion conductive inorganic solid electrolyte. The ion at this point is preferably an ion of metal belonging to Group 1 or 2 in the periodic table. As the inorganic solid electrolyte described above, a solid electrolyte material that is applied to a product of this type can be appropriately chosen to be used. Representative examples of an inorganic solid electrolyte include (i) a sulphide-based inorganic solid electrolyte and (ii) an oxide-based inorganic solid electrolyte.

(i) Sulfide-Based Inorganic Solid Electrolyte

It is preferable that the sulfide solid electrolyte contains sulfur (S), has ion conductivity of metal belonging to Group 1 or 2 in the periodic table and has electron insulation properties. Examples thereof include a lithium ion conductive inorganic solid electrolyte satisfying the composition presented in Formula (1) below.

LiaMbPcSd (1)

(In the formula, M represents an element selected from B, Zn, Si, Cu, Ga, and Ge. a to d represent composition ratios of the respective elements, and a:b:c:d satisfies 1 to 12:0 to 0.2:1:2 to 9.)

In Formula (1), in the composition ratios of Li, M, P, and S, it is preferable that b is 0. It is more preferable that b is 0 and the ratio of a, c, and d (a:c:d) is a:c:d=1 to 9:1:3 to 7. It is even more preferable that b is 0 and a:c:d=1.5 to 4:1:3.25 to 4.5. As described below, the composition ratios of the respective elements can be controlled by adjusting the blending amount of the raw material compound when the sulfide-based solid electrolyte is manufactured.

The sulfide-based solid electrolyte may be amorphous (glass) or may be crystallized (formed into glass ceramic), or a portion thereof may be crystallized.

In Li—P—S-based glass and Li—P—S-based glass ceramics, the ratio of Li₂S and P₂S₅ is preferably 65:35 to 85:15 and more preferably 68:32 to 75:25 in the molar ratio of Li₂S:P₂S₅. If the ratio of Li₂S and P₂S₅ is in the range described above, lithium ion conductance can be increased. Specifically, the lithium ion conductance can be preferably 1×10⁻⁴ S/cm or higher and more preferably 1×10⁻³ S/cm or higher.

Specific examples of these compounds include a compound obtained by using a raw material composition containing, for example, Li₂S and sulfide of an element of Groups 13 to 15. Specifically, examples thereof include Li₂S—P₂S₅, Li₂S—GeS₂, Li₂S—GeS₂—ZnS, Li₂S—Ga₂S₃, Li₂S—GeS₂—Ga₂S₃, Li₂S—GeS₂—P₂S₅, Li₂S—GeS₂—Sb₂S₅, Li₂S—GeS₂—Al₂S₃, Li₂S—SiS₂, Li₂S—Al₂S₃, Li₂S—SiS₂—Al₂S₃, Li₂S—SiS₂—P₂S₅, Li₂S—SiS₂—LiI, Li₂S—SiS₂—Li₄SiO₄, Li₂S—SiS₂—Li₃PO₄, and Li₁₀GeP₂S₁₂. Among these, a crystalline and/or amorphous raw material composition formed of Li₂S—P₂S₅, Li₂S—GeS₂—Ga₂S₃, Li₂SGeS₂—P₂S₅, Li₂S—SiS₂—P₂S₅, Li₂S—SiS₂—Li₄SiO₄, and Li₂S—SiS₂—Li₃PO₄ is preferable, since the crystalline and/or amorphous raw material composition has high lithium ion conductivity. Examples of the method of synthesizing a sulphide solid electrolyte material by using such a raw material composition include an amorphizing method. Examples of the amorphizing method include a mechanical milling method and a melt quenching method, and among these, a mechanical milling method is preferable, because a treatment in room temperature becomes possible, and thus the manufacturing step can be simplified.

(ii) Oxide-Based Inorganic Solid Electrolyte

It is preferable that the oxide-based solid electrolyte contains oxygen (O), has ion conductivity of metal belonging to Group 1 or 2 in the periodic table, and has electron insulation properties.

Specific examples of the compound include LiₓLa_{y}TiO₃ [x=0.3 to 0.7, y=0.3 to 0.7] (LLT), Li₇La₃Zr₂O₁₂ (LLZ), Li_{3.5}Zn_{0.25}GeO₄ having a lithium super ionic conductor (LISICON)-type crystal structure, La_{0.55}Li_{0.35}TiO₃ having a perovskite-type crystal structure, LiTi₂P₃O₁₂, and Lil+x+y(Al,Ga)x(Ti,Ge)₂-xSiyP₃-yO₁₂ (here, 0≦x≦1, 0≦y≦1) having a natrium super ionic conductor (NASICON)-type crystal structure, and Li₇La₃Zr₂O₁₂ having a garnet-type crystal structure. In addition, a phosphorus compound including Li, P, and O is desirable. Examples of the phosphorus compound include lithium phosphorate (Li₃PO₄), and LiPON or LiPOD (D is at least one type selected from Ti, V, Cr, Mn, Fe, Co, Ni, Cu, Zr, Nb, Mo, Ru, Ag, Ta, W, Pt, and Au) in which a portion of oxygen in lithium phosphorate is substituted with nitrogen. In addition, LiAON (A is at least one type selected from Si, B, Ge, Al, C, and Ga) and the like can be preferably used.

Among these, Lil+x+y(Al,Ga)x(Ti,Ge)₂-xSiyP₃-yO₁₂ (here, 0≦x≦1, 0≦y≦1) is preferable, since Lil+x+y(Al,Ga)x(Ti,Ge)₂-xSiyP₃-yO₁₂ has high lithium-ion conductivity, are chemically stable, and are easily managed. These may be used singly or two or more types thereof may be used in combination.

The ion conductance of the lithium-ion conductive oxide-based inorganic solid electrolyte is preferably 1×10⁻⁶ S/cm or higher, more preferably 1×10⁻⁵ S/cm or higher, and particularly preferably 5×10⁻⁵ S/cm or higher.

According to the invention, among these, an oxide-based inorganic solid electrolyte is preferably used. Since the oxide-based inorganic solid electrolyte generally has high hardness, the interface resistance in the all-solid-state secondary battery easily increases. If the invention is applied, an effect as a countermeasure thereof becomes prominent.

The inorganic solid electrolyte may be used singly or two or more types thereof may be used in combination.

When compatibility between battery performances and a decrease and maintenance effect of the interface resistance is considered, the concentration of the inorganic solid electrolyte in the solid electrolyte composition is preferably 50 mass % or more, more preferably 70 mass % or more, and particularly preferably 90 mass % or more with respect to 100 mass % of the solid component. In the same point of view, the upper limit of the concentration is preferably 99.9 mass % or less, more preferably 99.5 mass % or less, and particularly preferably 99.0 mass % or less. However, when the inorganic solid electrolyte is used together with the positive electrode active substance or the negative electrode active substance described below, it is preferable that the sum thereof is in the concentration range described above.

According to the invention, as the particles of the inorganic solid electrolyte, particles exhibiting at least two peaks in the accumulative particle size distribution measured by the dynamic light scattering-type particle diameter distribution measuring device are used. Here, unless described otherwise, the “peak” refers to a value that can be separated as a peak in conditions of the nonlinear least square method (the number of repetition: 100 times, accuracy: 0.000001, allowance: 5%, convergence: 0.0001).

Unless described otherwise, the average particle diameter of the inorganic solid electrolyte particles according to the invention refers to a value that is measured by conditions described in examples below.

The inorganic solid electrolyte particles are preferably formed with two types or more particles including inorganic solid electrolyte particles A and inorganic solid electrolyte particles B. The number of types of the particles is not particularly limited, but it is practical that the number of peaks is five or less. In the case where particles having three or more particle diameter size are used, a group having a maximum particle size is defined as the inorganic solid electrolyte particles A, and a group having a minimum particle size is defined as the inorganic solid electrolyte particles B. The identification of the particles is evaluated according to the definition of the peaks, and a case where the peak above is exhibited as one particle group.

Inorganic Solid Electrolyte Particles A

An average particle diameter da of the inorganic solid electrolyte particles A is preferably 2 μm or less, more preferably 1.9 μm or less, and particularly preferably 1.8 μm or less. The lower limit thereof is preferably 0.4 μm or greater, more preferably 0.5 μm or greater, and particularly preferably 0.6 μm or greater.

An accumulative 90% particle diameter is preferably 3.4 μm or less, more preferably 3.2 μm or less, and particularly preferably 3 μm or less. The lower limit thereof is preferably 0.7 μm or greater, more preferably 0.8 μm or greater, and particularly preferably 1 μm or greater.

If the scope of the particle diameter is caused to be the lower limit or greater, a homogeneous thin film can be easily formed. If the scope of the particle diameter is caused to be the upper limit or less, it is possible to prevent the manufacturing from being extremely complicated, it is easy to suitably maintain the number of particles, the resistance derived by the interface is suppressed without remarkably increasing the total area of particle interfaces, and favorable ion conductance can be realized. The scope of the average particle diameter of the particles A is the same as the maximum particle diameter peak (Pa) in the composition after mixing and the accumulative 90% particle diameter peak (Pa90) thereof.

Inorganic Solid Electrolyte Particles B

The average particle diameter db of the inorganic solid electrolyte particles B is preferably 1.5 μm or less, more preferably 1.3 μm or less, and particularly preferably 1.2 μm or less. The lower limit is preferably 0.1 μm or greater, more preferably 0.15 μm or greater, and particularly preferably 0.2 μm or greater.

The accumulative 90% particle diameter is preferably 2.5 μm or less, more preferably 2.3 μm or less, and particularly preferably 2 μm or less. The lower limit is preferably 0.2 μm or greater, more preferably 0.3 μm or greater, and particularly preferably 0.5 μm or greater.

If the scope of the particle diameter is the upper limit value or less, an effect obtained by using particles having different particle diameters is sufficiently exhibited, and thus the scope is preferable. If the scope of the particle diameter is the lower limit value or greater, manufacturing suitability is excellent and the resistance derived from the interface is suppressed without increasing the number of particles and not extremely increasing the total area of the particle interfaces such that the favorable ion conductance can be realized. Therefore, the scope is preferable. The scope of the average particle diameter of the particles B is the same as the maximum particle diameter peak (Pb) in the composition after mixing and the accumulative 90% particle diameter peak (Pb90) thereof.

The average particle diameter da of the inorganic solid electrolyte particles A and the average particle diameter db of the inorganic solid electrolyte particles B preferably satisfy the relationship of da>db. The difference between the average particle diameters (da−db) is preferably 0.1 or greater, more preferably 0.2 or greater, and particularly preferably 0.3 or greater. The upper limit is preferably 1.5 or less, more preferably 1 or less, and particularly preferably 0.8 or less. If the difference thereof is in a suitable scope, it is easy to perform filling more densely with two different types of particles, and thus the ion conductance enhanced. Therefore, the difference thereof is preferable.

The relationship between the inorganic solid electrolyte particles A and B above is defined with respect to solid electrolyte compositions which are products as follows. That is, the relationship between the peak (Pa) of the maximum particle diameter and the peak (Pb) of the minimum particle diameter of the inorganic solid electrolyte particles preferably satisfies Expression (1) below, more preferably satisfies Expression (1a) below, and particularly preferably satisfies Expression (1b) below.

0.05≦Pb/Pa≦0.75 (1)

0.1≦Pb/Pa≦0.72 (1a)

0.25≦Pb/Pa≦0.70 (1b)

In view of the raw material particles obtained by mixing these, the relationship between the average particle diameter db of the inorganic solid electrolyte particles B and the average particle diameter da of the inorganic solid electrolyte particles A is preferably Expression (2) below, more preferably Expression (2a) below, and particularly preferably Expression (2b) below.

0.05≦db/da≦0.75 (2)

0.1≦db/da≦0.72 (2a)

0.25≦db/da≦0.70 (2b)

If the relationship between particle diameters of the inorganic solid electrolyte particles A and the inorganic solid electrolyte particles B is as above, void when filling is densely performed by mixing the both (pressurization molding) is effectively decreased, and thus the relationship is preferable. As a result, the resistance derived from the interfaces in the solid electrolyte layer is effectively prevented, and thus favorable ion conductance can be exhibited. If the relationship is caused to be in the scope above, it is appropriate for manufacturing the inorganic solid electrolyte particles (particularly, particles B).

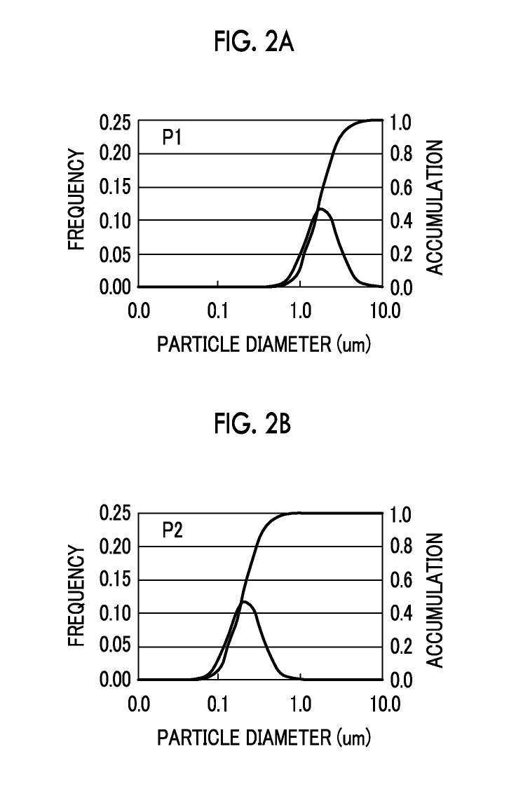

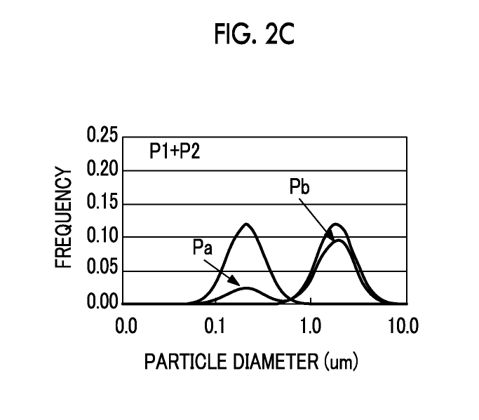

FIGS. 2A to 2C are graphs illustrating, for example, bimodality of two types of particles described above. FIGS. 2A and 2B respectively illustrate particles having independent particle size distribution, and FIG. 2C illustrates that, if particles illustrated in FIGS. 2A and 2B are mixed in a certain ratio, the particles become particles having bimodal distribution. In FIG. 2C, the blue line indicates particle size distribution of the particles Pa, the green line indicates particle size distribution of the particles Pb, and the red line indicates particle size distribution of the particles after Pa and Pb are mixed.

If the amounts of the particles of the inorganic solid electrolyte particles A and B are indicated in view of the solid electrolyte composition, respective peaks in the accumulative particle size distribution measured by the dynamic light scattering-type particle diameter distribution measuring device are assumed to follow the log-normal distribution and can be evaluated according to the peak area when the waveform is separated in the nonlinear least square method. That is, the ratio between the area (WPa) of the peak (Pa) of the maximum particle diameter and the area (WPb) of the peak (Pb) of the minimum particle diameter preferably satisfies Expression (3) below, more preferably satisfies Expression (3a), and particularly preferably satisfies Expression (3b).

0.01≦WPb/(WPa+WPb)≦0.8 (3)

0.05≦WPb/(WPa+WPb)≦0.6 (3a)

0.1≦WPb/(WPa+WPb)≦0.4 (3b)

With respect to the blending amount when the solid electrolyte composition is prepared, an addition amount (Wb) of the inorganic solid electrolyte particles B is preferably less than an addition amount (Wa) of the inorganic solid electrolyte particles A. The mass ratio thereof preferably satisfies Expression (4) below, more preferably Expression (4a), and particularly preferably Expression (4b).

0.01≦Wb/(Wa+Wb)≦0.8 (4)

0.05≦Wb/(Wa+Wb)≦0.6 (4a)

0.1≦Wb/(Wa+Wb)≦0.4 (4b)

If the ratio of the addition amounts of the inorganic solid electrolyte particles A and B is as described above, void when filling is densely performed by mixing the both (pressurization molding) is effectively decreased, and thus the ratio is preferable.

In the solid electrolyte composition according to the preferable embodiment of the invention, the particle diameters of the solid electrolyte particles included therein is in the suitable scope as described above, and the filling ability of the respective particles can be enhanced. Accordingly, the electric connection between the particles becomes better and thus it is expected that excellent ion conductivity is exhibited. Generally, since void between particles decreases, peeling becomes difficult, such that it is expected that repetitive charging and discharging properties become better.

(Binder)

A binder can be used in the solid electrolyte composition according to the invention. Accordingly, the inorganic solid electrolyte particles are bound, and more favorable ion conductivity can be realized. The types of the binders are not particularly limited, but styrene-acryl-based copolymer (for example, see JP2013-008611A and WO2011/105574A), a hydrogenated butadiene copolymer (for example, JP1999-086899A (JP-H11-086899A) and WO2013/001623A), a polyolefin-based polymer such as polyethylene, polypropylene, and polytetrafluoroethylene (for example, JP2012-99315A), a compound having a polyoxyethylene chain (see JP2013-008611A), a norbornene-based polymer (see JP2011-233422A), and the like can be used.

The weight average molecular weight of the polymer compound forming the binder is preferably 5,000 or greater, more preferably 10,000 or greater, and particularly preferably 30,000 or greater. The upper limit is preferably 1,000,000 or less and more preferably 400,000 or less. Unless described otherwise, the method for measuring the molecular weight follows the measuring condition examples below.

In view of the enhancement of the binding properties, the glass transition temperature (Tg) of the binder polymer is preferably 100° C. or less, more preferably 30° C. or less, and particularly preferably 0° C. or less. In view of manufacturing suitability or stability of performances, the lower limit is preferably −100° C. or greater and more preferably −80° C. or greater.

The binder polymer may be crystalline or non-crystalline. In the case where the binder polymer is crystalline, the melting point is preferably 200° C. or less, more preferably 190° C. or less, and particularly preferably 180° C. or less. The lower limit is not particularly limited, but the lower limit is preferably 120° C. or greater and more preferably 140° C. or greater.

According to the invention, unless described otherwise, the inorganic solid electrolyte particles, the Tg or the melting point of the binder polymer, and the softening temperature follows the measuring method (DSC measurement) employed in the examples below. The measurement of the created all-solid-state secondary battery can be performed, for example, by decomposing the battery, put electrodes into water, dispersing materials thereof, performing filtration, collecting remaining solids, and measuring the glass transition temperature in the method for measuring Tg described below.

The average particle diameter of the binder polymer particles is preferably 0.01 μm or greater, more preferably 0.05 μm or greater, and particularly preferably 0.1 min or greater. The upper limit thereof is preferably 500 μm or less, more preferably 100 μm or less, and particularly preferably 10 μm or less.

The standard deviation of the particle diameter distribution is preferably 0.05 or greater, more preferably 0.1 or greater, and particularly preferably 0.15 or greater. The upper limit is preferably 1 or less, more preferably 0.8 or less, and particularly preferably 0.6 or less.

Unless described otherwise, the average particle diameter or the particle dispersion degree of the polymer particles according to the invention follows the conditions employed in the examples below (dynamic scattering method).

According to the invention, it is preferable that the particle diameter of the binder polymer particles is smaller than the average particle diameter of the inorganic solid electrolyte particles. If the size of the polymer particles is caused to be in the range described above, it is possible to cause the inorganic solid electrolyte particles to have predetermined particle size distribution and also realize the favorable adhesiveness and the suppression of the interface resistance. With respect to the created all-solid-state secondary battery, the measurement can be performed, for example, by decomposing the battery, releasing the electrodes, measuring the electrode material in conformity with the method of the particle diameter measurement of the polymer described below, and excluding the measured value of the particle diameter of the particles other than the polymer which is measured in advance.

The blending amount of the binder is preferably 0.1 parts by mass or greater, more preferably 0.3 parts by mass or greater, and particularly preferably 1 part by mass or greater with respect to 100 parts by mass of the inorganic solid electrolyte (including an active substance, in case of being used). The upper limit is preferably 50 parts by mass or less, more preferably 20 parts by mass or less, and particularly preferably 10 parts by mass or less.

With respect to the solid electrolyte composition, the content of the binder is preferably 0.1 mass % or greater, more preferably 0.3 mass % or greater, and particularly preferably 1 mass % or greater in the solid component. The upper limit thereof is preferably 50 mass % or less, more preferably 20 mass % or less, and particularly preferably 10 mass % or less.

If the binder is used in the range described above, compatibility between the adherence of the inorganic solid electrolyte and the suppression of the interface resistance can be more effectively realized.

The binder may be used singly or two or more types thereof may be used in combination. The binder may be used in combination with other particles.

The binder particles may be made of only a specific polymer for forming this or may be formed in a state in which other types of materials (polymers, low molecular compounds, inorganic compounds, or the like) are included.

(Lithium Salt [Electrolyte Salt])

In the all-solid-state secondary battery of the invention, a lithium salt may be included in the solid electrolyte composition. As the lithium salt, a lithium salt that is generally used in a product of this type is preferable, and the type of the lithium salt is not particularly limited, but lithium salts described below are preferable.

(L-1) Inorganic lithium salt: An inorganic fluoride salt such as LiPF₆, LiBF₄, LiAsF₆, and LiSbF₆; a perhalogen acid salt such as LiClO₄, LiBrO₄, and LiIO₄; an inorganic chloride salt such as LiAlCl₄; and the like.

(L-2) Fluorine-containing organic lithium salt: a perfluoroalkane sulfonic acid salt such as LiCF₃SO₃; a perfluoroalkane sulfonylimide salt such as LiN(CF₃SO₂)₂, LiN(CF₃CF₂SO₂)₂, LiN(FSO₂)₂, and LiN(CF₃SO₂)(C₄F₉SO₂); a perfluoroalkane sulfonylmethide salt such as LiC(CF₃SO₂)₃; a fluoroalkyl fluoride phosphoric acid salt such as Li[PF₅(CF₂CF₂CF₃)], Li[PF₄(CF₂CF₂CF₃)₂], Li[PF₃(CF₂CF₂CF₃)₃], Li[PF₅(CF₂CF₂CF₂CF₃)], Li[PF₄(CF₂CF₂CF₂CF₃)₂], and Li[PF₃(CF₂CF₂CF₂CF₃)₃]; and the like.

(L-3) Oxalatoborate salt: lithium bis(oxalato)borate, lithium difluorooxalatoborate, and the like.

Among these, LiPF₆, LiBF₄, LiAsF₆, LiSbF₆, LiClO₄, Li(Rf¹SO₃), LiN(Rf¹SO₂)₂, LiN(FSO₂)₂, and LiN(Rf¹SO₂)(Rf²SO₂) are preferable, and a lithiumimide salt such as LiPF₆, LiBF₄, LiN(Rf¹SO₂)₂, LiN(FSO₂)₂, and LiN(Rf¹SO₂)(Rf²SO₂) is still more preferable. Here, each of Rf¹ and Rf² represents a perfluoroalkyl group.

The content of the lithium salt is preferably 0.1 parts by mass or greater and more preferably 0.5 parts by mass or greater with respect to 100 parts by mass of the solid electrolyte. The upper limit is preferably 10 parts by mass or less and more preferably 5 parts by mass or less.

The electrolyte used in the electrolytic solution may be used singly or two or more types thereof may be arbitrarily used in combination.

(Dispersion Medium)

In the solid electrolyte composition according to the invention, the dispersion medium in which the respective components are dispersed may be used. Examples of the dispersion medium include a water soluble organic solvent. Specific examples thereof include the followings.

Alcohol Compound Solvent

Methyl alcohol, ethyl alcohol, 1-propyl alcohol, 2-propyl alcohol, 2-butanol, ethylene glycol, propylene glycol, glycerine, 1,6-hexanediol, cyclohexanediol, sorbitol, xylitol, 2-methyl-2,4-pentanediol, 1,3-butanediol, 1,4-butanediol, and the like

Ether Compound Solvent (Including Hydroxy Group-Containing Ether Compound)

Dimethyl ether, diethyl ether, diisopropyl ether, dibutyl ether, t-butylmethyl ether, cyclohexylmethyl ether, anisole, tetrahydrofuran, alkylene glycol alkyl ether (ethylene glycol monomethyl ether, ethylene glycol monobutyl ether, diethylene glycol, dipropylene glycol, propylene glycol monomethyl ether, diethylene glycol monomethyl ether, triethylene glycol, polyethylene glycol, propylene glycol monomethyl ether, dipropylene glycol monomethyl ether, tripropylene glycol monomethyl ether, diethylene glycol monobutyl ether, diethylene glycol monobutyl ether, or the like)

Amide Compound Solvent

N,N-dimethylformamide, 1-methyl-2-pyrrolidone, 2-pyrrolidinone, 1,3-dimethyl-2-imidazolidinone, 2-pyrrolidinone, ε-caprolactam, formamide, N-methylformamide, acetoamide, N-methylacetoamide, N,N-dimethylacetoamide, N-methylpropaneamide, hexamethylphosphoric triamide, and the like

Ketone Compound Solvent

Acetone, methyl ethyl ketone, methyl isobutyl ketone, cyclohexanone, and the like

Aromatic Compound Solvent

Benzene, toluene, and the like

Aliphatic Compound Solvent

Hexane, heptane, cyclohexane, methylcyclohexane, octane, pentane, cyclopentane, and the like

Nitrile Compound Solvent

Acetonitrile and Isobutyronitrile

According to the invention, among these, it is preferable to use an ether compound solvent, a ketone compound solvent, an aromatic compound solvent, and an aliphatic compound solvent. With respect to the dispersion medium, the boiling point in the normal pressure (1 atmospheric pressure) is preferably 80° C. or greater and more preferably 90° C. or greater. The upper limit thereof is preferably 220° C. or less and more preferably 180° C. or less. The solubility of the binder with respect to the dispersion medium at 20° C. is preferably 20 mass % or less, more preferably 10 mass % or less, and particularly preferably 3 mass % or less. The lower limit is practically 0.01 mass % or greater.

The dispersion medium above may be used singly or two or more types thereof may be used in combination.

(Method for Preparing Solid Electrolyte Composition)

The solid electrolyte composition according to the invention is prepared in the common method, but it is preferable that, after the inorganic solid electrolyte particles A and the inorganic solid electrolyte particles B are respectively treated at least in the wet dispersion method or the dry dispersion method, the inorganic solid electrolyte particles A and the inorganic solid electrolyte particles B are mixed. Examples of the wet dispersion method include a ball mill, a bead mill, and a sand mill. In the same manner, examples of the dry dispersion method include a ball mill, a bead mill, and a sand mill. After the dispersion, filtration is appropriately performed such that particles not having predetermined particle diameter or an aggregate can be removed.

In order to disperse the inorganic solid electrolyte particles A and the inorganic solid electrolyte particles B in a wet type or a dry type, various dispersion media such as dispersion balls or dispersion beads can be used. Among these, zirconia beads, titania beads, alumina beads, and steel beads which are dispersion media having high specific gravity are appropriate. The particle diameters and the filling rates of these dispersion media are used in an optimized manner.

(Positive Electrode Active Substance)

The positive electrode active substance is contained in the solid electrolyte composition according to the invention. In this manner, a composition for a positive electrode material can be made. Transition metal oxide is preferably used in the positive electrode active substance. Among them, transition metal oxide having a transition element M^{a} (I type or more elements selected from Co, Ni, Fe, Mn, Cu, and V) is preferable. A mixed element M^{b} (an element in Group 1 (Ia) of the periodic table of metal other than lithium, an element in Group 2 (IIa), Al, Ga, In, Ge, Sn, Pb, Sb, Bi, Si, P, B, and the like) may be mixed. Examples of this transition metal oxide include a specific transition metal oxide including oxide expressed by any one of Formulae (MA) to (MC) below or include V₂O₅ and MnO₂, as additional transition metal oxide. A particle-state positive electrode active substance may be used in the positive electrode active substance. Specifically, it is possible to use a transition metal oxide to which a lithium ion can be reversibly inserted or released, but it is preferable to use the specific transition metal oxide described above.

Examples of the transition metal oxide appropriately include oxide including the transition element M^{a}. At this point, the mixed element M^{b} (preferably Al) and the like are mixed. The mixture amount is preferably 0 mol % to 30 mol % with respect to the amount of the transition metal. It is more preferable that the transition element obtained by synthesizing elements such that the molar ratio of Li/M^{a} becomes 0.3 to 2.2.

[Transition Metal Oxide Expressed by Formula (MA) (Layered Rock Salt Structure)]

As the lithium-containing transition metal oxide, metal oxide expressed by the following formula is preferable.

LiₐM¹O_{b} (MA)

In the formula, M¹ has the same meaning as M^{a} above, a represents 0 to 1.2 (preferably 0.2 to 1.2) and preferably represents 0.6 to 1.1. b represents 1 to 3, and preferably 2. A portion of M¹ may be substituted with the mixed element M^{b}. The transition metal oxide expressed by Formula (MA) above typically has a layered rock salt structure.

The transition metal oxide according to the invention is more preferably expressed by the following formulae.

Li_{g}CoOₖ (MA-1)

Li_{g}NiOₖ (MA-2)

Li_{g}MnOₖ (MA-3)

Li_{g}CoⱼNiₗ₋ⱼOₖ (MA-4)

Li_{g}NiⱼMnₗ₋ⱼOₖ (MA-5)

Li_{g}CoⱼNiⱼAlₗ₋ⱼ₋ᵢOₖ (MA-6)

Li_{g}CoⱼNiᵢMnₗ₋ⱼ₋ᵢOₖ (MA-7)

Here, g has the same meaning as a above. j represents 0.1 to 0.9. i represents 0 to 1. However, l-j-i becomes 0 or greater. k has the same meaning as b above. Specific examples of the transition metal compound include LiCoO₂ (lithium cobalt oxide [LCO]), LiNi₂O₂ (lithium nickel oxide), LiNi_{0.85}Co_{0.01}Al_{0.05}O₂ (lithium nickel cobalt aluminum oxide [NCA]), LiNi_{0.33}CO_{0.33}Mn_{0.33}O₂ (lithium nickel cobalt manganese oxide [NMC]), and LiNi_{0.5}Mn_{0.5}O₂ (lithium manganese oxide).

Though partially overlapped, if the transition metal oxide expressed by Formula (MA) is indicated by changing the indication, the following are also provided as preferable examples.

Li_{g}NiₓMn_{y}Co_{z}O₂ (x>0.2,y>0.2,z≧0,x+y+z=1) (i)

Representative transition metal oxide thereof:

Li_{g}Ni_{1/3}Mn_{1/3}Co_{1/3}O₂

Li_{g}Ni_{1/2}Mn_{1/2}O₂

Li_{g}NiₓCo_{y}Al_{z}O₂ (x>0.7,y>0.1,0.1>z≧0.05,x+y+z=1) (ii)

Representative transition metal oxide thereof:

Li_{g}Ni_{0.8}C_{0.15}Al_{0.05}O₂

[Transition Metal Oxide Expressed by Formula (MB) (Spinel-Type Structure)]

Among them, as the lithium-containing transition metal oxide, transition metal oxide expressed by Formula (MB) below is also preferable.

Li_{c}M²₂O_{d} (MB)

In the formula, M² has the same meaning as M^{a} above. c represents 0 to 2 (preferably 0.2 to 2) and preferably represents 0.6 to 1.5. d represents 3 to 5, and preferably represents 4.

The transition metal oxide expressed by Formula (MB) is more preferably transition metal oxide expressed by the following formulae.

LiₘMn₂Oₙ (MB-1)

LiₘMnₚAl₂₋ₚOₙ (MB-2)

LiₘMnₚNi₂₋ₚOₙ (MB-3)

m has the same meaning as c. n has the same meaning as d. p represents 0 to 2. Specific examples of the transition metal compound include LiMn₂O₄ and LiMn_{1.5}Ni_{0.5}O₄.

The transition metal oxide expressed by Formula (MB) is more preferably transition metal oxide expressed by the following formulae.

LiCoMnO₄ (a)

Li₂FeMn₃O₈ (b)

Li₂CuMn₃O₈ (c)

Li₂CrMn₃O₈ (d)

Li₂NiMn₃O₈ (e)

Among the above, in view of high capacity and high output, an electrode including Ni is more preferable.

[Transition Metal Oxide Expressed by Formula (MC)]

As the lithium-containing transition metal oxide, lithium-containing transition metal phosphorus oxide is preferably used. Among them, transition metal oxide expressed by Formula (MC) below is also preferable.

Li_{c}M³(PO₄)_{f} (MC)

In the formula, e represents 0 to 2 (preferably 0.2 to 2) and preferably 0.5 to 1.5. f represents 1 to 5 and preferably represents 0.5 to 2.

M³ above represents one or more types of elements selected from V, Ti, Cr, Mn, Fe, Co, Ni, and Cu. M³ above may be substituted with other metal such as Ti, Cr, Zn, Zr, and Nb, in addition to the mixed element M^{b} above. Specific examples thereof include an olivine-type iron phosphate salt such as LiFePO₄ and Li₃Fe₂(PO₄)₃, iron pyrophosphates such as LiFeP₂O₇, cobalt phosphates such as LiCoPO₄, and a monoclinic nasicon-type vanadium phosphate salt such as Li₃V₂(PO₄)₃ (vanadium lithium phosphate).

The values of a, c, g, m, and e representing the composition of Li are values that are changed depending on charging and discharging, and are typically evaluated by the values in a stable state when Li is contained. In Formulae (a) to (e) above, the composition of Li is indicated with specific values, but this is changed depending on an operation of the battery in the same manner.

The average particle size (diameter) of the positive electrode active substance is not particularly limited, but the average particle size is preferably 0.1 μm to 50 μm. In order to cause the positive electrode active substance to have a predetermined particle size (diameter), a general pulverizer and a general classifier may be used. The positive electrode active substance obtained by the baking method may be used after being washed with water, an acidic aqueous solution, an alkaline aqueous solution, or an organic dissolving agent.

The concentration of the positive electrode active substance is not particularly limited, but the concentration in the solid electrolyte composition is preferably 20 mass % to 90 mass % and more preferably 40 mass % to 80 mass % with respect to 100 mass % of the solid component.

The positive electrode active substance may be used singly or two or more types thereof may be used in combination.

(Negative Electrode Active Substance)

The negative electrode active substance may be contained in the solid electrolyte composition according to the invention. In this manner, a composition for the negative electrode material can be made. As the negative electrode active substance, an active substance to which a lithium ion can be reversibly inserted or released is preferable. The material is not particularly limited, and examples thereof include carbonaceous material, metal oxide such as tin oxide and silicon oxide, metal composite oxide, a single substance of lithium, a lithium alloy such as a lithium aluminum alloy, and metal that can form an alloy with lithium such as Sn or Si. Among these, the carbonaceous material or lithium composite oxide is preferably used in view of credibility. As the metal composite oxide, metal composite oxide that can occlude or release lithium is preferable. The material thereof is not particularly limited, but a material that contains titanium and/or lithium as the constituent component is preferable in view of characteristics at high current density.

The carbonaceous material used as the negative electrode active substance is a material that is substantially made of carbon. Examples thereof include petroleum pitch, natural graphite, artificial graphite such as vapor phase-grown graphite, and a carbonaceous material obtained by baking various synthetic resins such as a PAN-based resin or a furfuryl alcohol resin. Examples thereof further include various carbon fibers such as a PAN-based carbon fiber, a cellulose-based carbon fiber, a pitch-based carbon fiber, a vapor phase-grown carbon fiber, a dehydrated PVA-based carbon fiber, a lignin carbon fiber, a glass-state carbon fiber, and an active carbon fiber, a mesophase microsphere, a graphite whisker, and a flat plate-shaped graphite.

These carbonaceous materials may be divided into a hardly graphitizable carbon material and a graphite-based carbon material according to the degree of graphitization. The carbonaceous material preferably has surface intervals, density, and sizes of crystallite as disclosed in JP1987-22066A (JP-S62-22066A), JP1990-6856A (JP-H2-6856A), and JP1991-45473A (JP-H3-45473A). The carbonaceous material does not have to be a single material, and a mixture of natural graphite and artificial graphite disclosed in JP1993-90844A (JP-H5-90844A), graphite having a coating layer disclosed in JP1994-4516A (JP-H6-4516A), and the like can be used.

As the metal oxide and metal composite oxide that are applied as the negative electrode active substance, amorphous oxide is particularly preferable, and, further, chalcogenide which is a reaction product of a metal element and an element in Group 16 in the periodic table can be preferably used. The expression “amorphous” herein means to have a broad scattering band having a vertex in an area of 20° to 40° in 2θ values in the X-ray diffraction method using CuKα rays, and may have crystalline diffraction lines. The strongest strength of the crystalline diffraction lines seen at 40° to 70° in the 2θ values is preferably 100 times or less and more preferably 5 times or less in the diffraction line intensity in the vertex of a broad scattering band seen at 20° to 40° in the 2θ value, and it is particularly preferable that oxide does not have a crystalline diffraction line.

Among the compound groups made of amorphous oxide and chalcogenide, amorphous oxide and chalcogenide of a metalloid element are more preferable, and an element of Groups 13 (IIIB) to 15 (VB) in the periodic table, a single substance of Al, Ga, Si, Sn, Ge, Pb, Sb, or Bi or oxide made of a combination obtained by combining two or more types thereof, and chalcogenide are particularly preferable. Specific examples of preferable amorphous oxide and chalcogenide preferably include Ga₂O₃, SiO, GeO, SnO, SnO₂, PbO, PbO₂, Pb₂O₃, Pb₂O₄, Pb₃O₄, Sb₂O₃, Sb₂O₄, Sb₂O₅, Bi₂O₃, Bi₂O₄, SnSiO₃, GeS, SnS, SnS₂, PbS, PbS₂, Sb₂S₃, Sb₂S₅, and SnSiS₃. These may be composite oxide with lithium oxide, for example, Li₂SnO₂.

The average particle size (diameter) of the negative electrode active substance is preferably 0.1 μm to 60 μm. In order to cause the negative electrode active substance to have a predetermined particle size (diameter), a well-known pulverizer and a well-known classifier are used. For example, a mortar, a ball mill, a sand mill, a vibrating ball mill, a satellite ball mill, a planetary ball mill, a swirling air stream-type jet mill, and a sieve are appropriately used. At the time of pulverizing, wet pulverization in which an organic solvent such as water or methanol coexist may be performed, if necessary. In order to obtain a desired particle diameter, classification is preferably performed. A pulverization method is not particularly limited, and a sieve, an air classifier, or the like can be used, if necessary. As the classification, both dry-type classification and wet-type classification can be used.

The chemical formula of the compound obtained by the baking method can be calculated in an inductive coupling plasma (ICP) emission spectrophotometric analysis method as a measuring method or can be calculated from a mass difference between particles before and after baking, as a simple method.

Examples of the negative electrode active substance that can be used together with an amorphous oxide negative electrode active substance mainly using Sn, Si, and Ge appropriately include a carbon material that can occlude and release lithium ion, lithium metal or lithium, lithium alloy, or metal that can be formed to an alloy with lithium.

The concentration of the negative electrode active substance is not particularly limited, but the concentration in the solid electrolyte composition is preferably 10 mass % to 80 mass % and more preferably 20 mass % to 70 mass % with respect to 100 mass % of the solid component.

The embodiment above describes an example in which a positive electrode active substance and a negative electrode active substance are contained in the solid electrolyte composition according to the invention, but the invention is not limited to thereto. For example, a paste including a positive electrode active substance and a negative electrode active substance as the composition that does not include inorganic solid electrolyte particles having the specific particle size distribution may be prepared. At this point, it is preferable to contain the inorganic solid electrolyte that is generally applied. In this manner, the positive electrode material and the negative electrode material which are commonly used are combined, and the solid electrolyte composition relating to the preferable embodiment of the invention may be used to form an inorganic solid electrolyte layer. The conductive assistance may be suitably contained in the active substance layer of the positive electrode and the negative electrode, if necessary. General examples of the electron conductive material include a carbon fiber, such as graphite, carbon black, acetylene black, Ketjen black, and a carbon nanotube, metal powders, a metal fiber, and a polyphenylene derivative.

The negative electrode active substance may be used singly or two or more types thereof may be used in combination.

<Collector (Metallic Foil)>

It is preferable that an electron conductor that does not cause a chemical change is used as the collector of the positive-negative electrodes. As the collector of the positive electrode, in addition to aluminum, stainless steel, nickel, titanium, and the like, a product obtained by treating carbon, nickel, titanium, or silver on the surface of aluminum and stainless steel is preferable. Among them, aluminum and an aluminum alloy are more preferable. As the negative electrode collector, aluminum, copper, stainless steel, nickel, and titanium are preferable, and aluminum, copper, and a copper alloy are more preferable.

As the form of the collector, a sheet-shaped collector is commonly used, but a net, a punched collector, a lath body, a porous body, a foaming body, a molded body of a fiber group, and the like can be used. The thickness of the collector is not particularly limited, but the thickness is preferably 1 μm to 500 μm. Unevenness is preferably formed on the collector surface by a surface treatment.

<Manufacturing of all-Solid-State Secondary Battery>

Manufacturing of the all-solid-state secondary battery may be performed by the common method. Specifically, examples of the method include a method for making an electrode sheet for a battery on which a film is formed by applying the solid electrolyte composition above on a metallic foil that becomes a collector. For example, the composition that forms the positive electrode material is applied on the metallic foil so as to form the film. Subsequently, the composition of the inorganic solid electrolyte is applied on the upper surface of the positive electrode active substance layer of the electrode sheet for the battery so as to form the film. In the same manner, it is possible to obtain a desired structure of the all-solid-state secondary battery by forming the film of the active substance of the negative electrode and providing the collector (metallic foil) on the negative electrode side. The method for applying the respective compositions may be performed by the common method. At this point, after the composition for forming the positive electrode active substance layer, the composition for forming the inorganic solid electrolyte layer, and the composition for forming the negative electrode active substance layer are respectively applied, it is preferable to perform the heating treatment. The heating temperature is not particularly limited. Specifically, the heating temperature is preferably 30° C. or greater and more preferably 60° C. or greater. The upper limit thereof is preferably 300° C. or less and more preferably 250° C. or less.

<Use of all-Solid-State Secondary Battery>

The all-solid-state secondary battery according to the invention can be applied to various uses. The use aspect is not particularly limited, but, if the all-solid-state secondary battery is mounted in an electronic device, examples thereof include a notebook personal computer, a pen input personal computer, a mobile computer, an electron book player, a cellular phone, a cordless phone slave unit, a pager, a handy terminal, a portable fax machine, a portable copying machine, a portable printer, a headphone stereo, a video movie, a liquid crystal television, a handy cleaner, a portable CD, a mini disc, an electric shaver, a transceiver, an electronic organizer, a calculator, a memory card, a portable tape recorder, radio, and a backup power supply. Examples of additional consumer use include an automobile, an electric motor vehicle, a motor, lighting equipment, a toy, a game machine, a load conditioner, a clock, a stroboscope, a camera, and medical equipment (a pacemaker, a hearing aid, and a shoulder massager). The all-solid-state secondary battery can be used for military or space. The all-solid-state secondary battery can be combined with a solar battery.

Among these, the all-solid-state secondary battery is preferably applied to an application that requires discharging properties at high capacity and a high rate. For example, in an electric storage facility and the like in which high capacity enhancement is expected in the future, high credibility is necessary, and thus compatibility between battery properties is required. A high capacity secondary battery is mounted on an electric car and the like, a use in which charging is performed everyday at home is assumed, and credibility at overcharging is further required. According to the invention, an excellent effect can be achieved in response to these use forms.

According to the preferable embodiment of the invention, respective applications as follows are provided.
A solid electrolyte composition (a composition for electrodes of a positive electrode or a negative electrode) that includes an active substance that can insert or release ion of metal belonging to Group 1 or 2 of the periodic table.
An electrode sheet for a battery obtained by forming a film of a solid electrolyte composition on a metallic foil.
An all-solid-state secondary battery including a positive electrode active substance layer, a negative electrode active substance layer, and an inorganic solid electrolyte layer, in which at least one of the positive electrode active substance layer, the negative electrode active substance layer, or the inorganic solid electrolyte layer is a layer formed of a solid electrolyte composition.
A method for manufacturing an electrode sheet for a battery by disposing the solid electrolyte composition on a metallic foil, and forming a film with this solid electrolyte composition.

An all-solid-state secondary battery manufacturing method for manufacturing an all-solid-state secondary battery in the method for manufacturing an electrode sheet for a battery.

The all-solid-state secondary battery refers to a secondary battery that is formed of a positive electrode, a negative electrode, and an electrolyte which are all solid. In other words, the all-solid-state secondary battery is different from an electrolyte solution-type secondary battery in which a carbonate-based solvent is used as an electrolyte. Among these, the invention relates to an inorganic all-solid-state secondary battery. The all-solid-state secondary battery is classified into the polymer all-solid-state secondary battery using a high molecular compound such as polyethylene oxide as an electrolyte and the inorganic all-solid-state secondary battery using LLT or LLZ. A high molecular compound can be applied as binders of the positive electrode active substance, the negative electrode active substance, and the inorganic solid electrolyte particle, without preventing application to an inorganic all-solid-state secondary battery.

The inorganic solid electrolyte is different from the electrolyte (high molecular electrolyte) using a high molecular compound as an ion conducting medium, and the inorganic compound becomes an ion conducting medium. Specific examples thereof include LLT or LLZ above. The inorganic solid electrolyte itself substantially does not release a positive ion (Li ion), but typically exhibits an ion transporting function in the form of obtaining positive ions in a crystal lattice. In contrast, an electrolyte solution or a material that becomes a supply source of an ion that is added to a solid electrolyte layer and releases a positive ion (Li ion) is called an electrolyte, but when the electrolyte is differentiated from the electrolyte as the ion transferring material, the electrolyte is called an “electrolyte salt” or a “supporting electrolyte”. Examples of the electrolyte salt include lithium bistrifluoromethane sulfone imide (LiTFSI).

In this specification, the expression “composition” means a mixture in which two or more components are evenly mixed. However, evenness may be substantially maintained, and aggregation or uneven distribution may partially occur in a range in which a desired effect is exhibited. In the case of the solid electrolyte composition, the solid electrolyte composition refers to the composition (typically in a paste state) to become a material for basically forming the electrolyte layer, and the electrolyte layer that is formed by curing the composition is not included therein.

### EXAMPLES

Hereinafter, the invention is specifically described with reference to examples, but the invention is not limited thereto. In the examples below, the expressions “part” and “%” are on a mass basis, unless otherwise described.

(Preparation Example of Inorganic Solid Electrolyte Particles)

After 160 zirconia beads having the diameter of 5 mm were introduced to a zirconia 45 mL container (manufactured by Fritsch Japan Co., Ltd.), 9.0 g of the inorganic solid electrolyte LLT (manufactured by Toshima Manufacturing Co., Ltd.), 0.3 g of HSBR (DYNARON 1321P manufactured by JSR Corporation) as a binding material, and 15.0 g of toluene as a dispersion medium were added, the container was set to a planetary ball mill P-7 manufactured by Fritsch Japan Co., Ltd., and the wet dispersion was performed for 90 minutes at the rotation speed of 360 rpm, so as to obtain inorganic solid electrolyte particles PT1. The average particle diameter was 1.8 μm, and the accumulative 90% particle diameter was 3.0 μm.

The weight molecular weight of the HSBR was 200,000, and Tg was −50° C.

160 zirconia beads having the diameter of 5 mm were introduced to a zirconia 45 mL container (manufactured by Fritsch Japan Co., Ltd.), 9.0 g of the inorganic solid electrolyte LLT (manufactured by Toshima Manufacturing Co., Ltd.) was input, the container was set to a planetary ball mill P-7 manufactured by Fritsch Japan Co., Ltd., the dry dispersion was performed for 120 minutes at the rotation speed of 300 rpm, 15.3 g of the HSBR/toluene solution obtained by dissolving 0.3 g of HSBR (DYNARON 1321P manufactured by JSR Corporation) in 15.0 g of toluene in advance in room temperature was added, and stirring was performed for five minutes at the rotation speed of 100 rpm, so as to obtain inorganic solid electrolyte particles PT2. The average particle diameter was 1.2 μm, and the accumulative 90% particle diameter was 2.0 μm.

The inorganic solid electrolyte particles PT3 to PT6, and PTc1 to PTc3 having predetermined particle diameters presented in Table 1 were prepared in the same method except for changing dispersion time or the like.

The dry (No. 104) particles were dispersed in the same manner as described above, except for inserting the solid electrolyte and the balls in the ball mill (not inserting the polymer and the solvent). In this manner, the inorganic solid electrolyte particles PTd1 and PTd2 were prepared.

As illustrated in Table 1, the inorganic solid electrolyte particles PZ1 and PZ2 were prepared in the same manner as PT1 and PT2 except for changing the inorganic solid electrolyte to LLZ (manufactured by Toshima Manufacturing Co., Ltd.).

### Example 1

Various inorganic solid electrolyte slurries obtained in the preparation example were mixed in types and ratios presented in Table 1, the mixture in the total weight of 25 g was input to a zirconia 45 mL container (manufactured by Fritsch Japan Co., Ltd.) together with 160 zirconia beads having the diameter of 5 mm, and mixing and stirring were performed with a planetary ball mill P-7 manufactured by Fritsch Japan Co., Ltd. at the rotation speed of 100 rpm for 5 minutes. The obtained inorganic solid electrolyte composition slurry was applied on an aluminum foil having the thickness of 20 μm with an applicator having arbitrary clearance and was dried at 80° C. for one hour, so as to obtain an inorganic solid electrolyte sheet. Here, in the conditions (rotation speed and time) of the ball mill dispersion, there were little changes in the diameters of the inorganic solid electrolyte particles.

The measuring of the particle diameter is performed in the method for measuring the particle diameter-particle size distribution described below. The sample (dispersion product) for the measuring was prepared according to the method for preparing the slurry above. The particle size distribution of the inorganic solid electrolyte particles after the mixture which was used in the examples was illustrated in FIGS. 2A to 2C.

<Particle Diameter and Method for Measuring Particle Size Distribution>

The inorganic solid electrolyte particle dispersion product was isolated in a 20 ml sample bottle by using the dynamic light scattering-type particle diameter distribution measuring device (LB-500 manufactured by HORIBA, Ltd.) comforming to JIS8826:2005, the concentration of the solid contents was diluted and adjusted to became 0.2 mass % by toluene, data acquisition was performed for 50 times by using 2 ml of a quartz cell for measuring at the temperature of 25° C., and the arithmetic mean based on the obtained volumes was set to be an average particle diameter. Accumulative 90% of particle diameters from the fine particle side of the accumulative particle size distribution was set to an accumulative 90% particle diameter. The average particle diameter of the particles before mixture was measured in this method.

<Method of Separating Waveforms of Measurement Value>

The particle diameter and the accumulative 90% particle diameter of the inorganic solid electrolyte before mixture were estimated by assuming the log-normal distribution from the particle size distribution measurement results of the inorganic solid electrolyte after the mixture and separating the waveforms by the least squares method. Specifically, the inorganic solid electrolyte dispersion product after mixture was measured with the dynamic light scattering-type particle diameter distribution measuring device (LB-500 manufactured by HORIBA, Ltd.), the obtained measurement results were subjected to waveform separation by using a solver function in Excel (spread sheet software manufactured by Microsoft Corporation), so as to calculate the respective particle diameters and the accumulative 90% particle diameter of the inorganic solid electrolyte before mixture. It was confirmed that the average particle diameter and the 90% particle diameter which were calculated in this manner coincide with the respective average particle diameters and 90% particle diameters before preparation. The results thereof were presented in Table 1.

<Measuring of Porosity>

The thickness and the weight of the inorganic solid electrolyte sheet obtained above were measured, apparent density was calculated, porosity c was calculated by the expression below. The results were presented in Table 1 according to the evaluation criteria below.

ε=1−(true specific gravity of used solid electrolyte particles/apparent specific gravity of an inorganic solid electrolyte sheet)

A: An inorganic solid electrolyte sheet having porosity or less than than the porosity of Comparative Example c11

B: An inorganic solid electrolyte sheet having porosity greater than the porosity of Comparative Example c11 and equal to or less than +10% of the porosity of Comparative Example c11

C: An inorganic solid electrolyte sheet having porosity greater than +10% of the porosity of Comparative Example c11

<Measuring of Ion Conductance>

The inorganic solid electrolyte sheet obtained above was punched in a shape of a disc having the diameter of 14.5 mm, so as to manufacture a coin battery. From the outside of the coin battery, the inorganic solid electrolyte sheet was pinched to a jig that was able to apply the pressure of 500 kgf/cm² between the electrodes, the ion conductance was obtained in the AC impedance method in a thermostat at 30° C. The results were presented in Table 1 according to the evaluation criteria below.

A: Inorganic solid electrolyte sheet having ion conductance greater than +10% of the ion conductance of Comparative Example c11

B: Inorganic solid electrolyte sheet having ion conductance greater than the ion conductance of Comparative Example c11 and equal to or less than +10% of the ion conductance of Comparative Example c11

C: Inorganic solid electrolyte sheet having ion conductance or less than ion conductance of the ion conductance of Comparative Example c11

TABLE 1

| | Solid electrolyte | | | | | | | | | | | | | | | |
|---|---|---|---|---|---|---|---|---|---|---|---|---|---|---|---|---|
| | A | | | | | | B | | | | | | | | | |
| | | | Manu- | | | WPa | | | Manu- | | | WPb | | WPb/ | | |
| | | | fac- | Pa | Pa90 | parts | | | fac- | Pb | Pb90 | parts | | (WPa + | | |
| Test | | | turing | μm | μm | by | | | turing | μm | μm | by | Pb/Pa | WPb) | | Ion |
| No. | No. | Type | method | 2-0.4 | 3.4-0.7 | mass | No. | Type | method | 1.5-0.1 | 2.5-0.2 | mass | 0.05-0.75 | 0.01-0.8 | Porosity | conductance |
| 101 | PT1 | LLT | Wet | 1.8 | 3.0 | 100 | PT2 | LLT | Wet | 1.2 | 2.0 | 30 | 0.67 | 0.23 | A | A |
| 102 | PT2 | LLT | Wet | 1.2 | 2.0 | 100 | PT3 | LLT | Wet | 0.6 | 1.0 | 13 | 0.50 | 0.12 | A | A |
| 103 | PT3 | LLT | Wet | 0.6 | 1.0 | 100 | PT4 | LLT | Wet | 0.2 | 0.3 | 8 | 0.33 | 0.07 | A | A |
| 104 | PTd1 | LLT | Dry | 1.2 | 2.0 | 100 | PTd2 | LLT | Dry | 0.6 | 1.0 | 13 | 0.50 | 0.12 | A | A |
| 105 | PZ1 | LLZ | Wet | 1.8 | 3.0 | 100 | PZ2 | LLZ | Wet | 1.2 | 2.0 | 30 | 0.67 | 0.23 | A | A |
| c11 | PT2 | LLT | Wet | 1.2 | 2.0 | 100 | — | — | — | — | — | — | — | — | C | C |
| c12 | PTd1 | LLT | Dry | 1.2 | 2.0 | 100 | — | — | — | — | — | — | — | — | C | C |
| c13 | PTc1 | LLT | Wet | 2.5 | 4.2 | 100 | PT2 | LLT | Wet | 1.2 | 2.0 | 20 | 0.48 | 0.17 | B | B |
| c14 | PTc2 | LLT | Wet | 0.2 | 0.3 | 100 | PT6 | LLT | Wet | 0.1 | 0.2 | 13 | 0.50 | 0.12 | B | B |
| c15 | PT1 | LLT | Wet | 1.8 | 3.0 | 100 | PTc3 | LLT | Wet | 0.05 | 0.08 | 20 | 0.03 | 0.17 | B | B |
| c16 | PT5 | LLT | Wet | 1.5 | 2.5 | 100 | PT2 | LLT | Wet | 1.2 | 2.0 | 20 | 0.80 | 0.17 | B | B |

Pa: Peak position of maximum particle diameter (μm)
Pa₉₀: Accumulative 90% of particle diameter of the solid electrolyte particles A
Pb: Peak position of minimum particle diameter (μm)
Pb₉₀: Accumulative 90% of particle diameter of solid electrolyte particles B
LLT: LiₓLa_{y}TiO₃ [x = 0.3 to 0.7, y = 0.3 to 0.7]
LLZ: Li₇La₃Zr₂O₁₂
WPa: Area of peak Pa of maximum particle diameter
WPb: Area of peak Pb of maximum particle diameter

According to the results above, it is understood that the solid electrolyte composition of the invention causes the void between the inorganic solid electrolyte particles to be small and thus favorable ion conductivity can be realized. With respect to all samples of the inorganic solid electrolyte particles, da, db, Wa, and Wb respectively coincide with Pa, Pb, WPa, and WPb.

It was confirmed that peeling resistance of the electrolyte layer in the example was favorable and durability was excellent.

<Measuring of Molecular Weight>

The weight average molecular weight in terms of standard polystyrene was measured by the gel permeation chromatography (GPC). With respect to the measuring method, the weight average molecular weight was measured by the method in the conditions below.

(Condition)

Column: Column obtained by connecting TOSOH TSKgel Super HZM-H, TOSOH TSKgel Super HZ4000, and TOSOH TSKgel Super HZ2000 was used.

Carrier: Tetrahydrofuran

### Example 2

The same test was performed by changing the solid electrolyte particles A and B used in Test 101 and c11 as presented in Table 2 below. The results measured with respect to the porosity and ion conductance were also presented in Table 2. From these results, according to the invention, it is understood that favorable performances were exhibited in the case of using a sulfide-based solid electrolyte.

TABLE 2

| | Solid electrolyte | | | | | | | | | | | | | | | |
|---|---|---|---|---|---|---|---|---|---|---|---|---|---|---|---|---|
| | A | | | | | | B | | | | | | | | | |
| | | | Manu- | | | WPa | | | Manu- | | | WPb | | WPb/ | | |
| | | | fac- | Pa | Pa90 | parts | | | fac- | Pb | Pb90 | parts | | (WPa + | | Ion |
| Test | | | turing | μm | μm | by | | | turing | μm | μm | by | Pb/Pa | WPb) | | conduc- |
| No | No. | Type | method | 2-0.4 | 3.4-0.7 | mass | No. | Type | method | 1.5-0.1 | 2.5-0.2 | mass | 0.05-0.75 | 0.01-0.8 | Porosity | tance |
| 201 | PSI | Sulfide | Wet | 1.5 | 2.5 | 100 | PS2 | Sulfide | Wet | 0.9 | 1.5 | 20 | 0.60 | 0.17 | A | A |
| c21 | PSI | Sulfide | Wet | 1.5 | 9.5 | 100 | — | — | — | — | — | — | — | — | C | C |

Sulfide: A sulfide inorganic solid electrolyte (Li/P/S-based glass) synthesized as below

Synthesization of a Sulfide Inorganic Solid Electrolyte (Li/P/S-Based Glass)

2.42 g of lithium sulfide (Li₂S, manufactured by Sigma-Aldrich Co., LLC., purity>99.98%), and 3.90 g of diphosphorus pentasulfide (P₂S₅, manufactured by Sigma-Aldrich Co., LLC., purity>99%) were respectively weighed in a glove box under argon atmosphere (dew point: −70° C.), and were introduced to a mortar. Li₂S and P₂S₅ satisfied Li₂S:P₂S₅=75:25 in the molar ratio. In the agate mortar, mixture was performed for five minutes by using agate pestle.

66 zirconia beads having the diameter of 5 mm were introduced to a 45 mL zirconia container (manufactured by Fritsch Japan Co., Ltd.), the total amounts of the mixture described above were introduced, and the container was completely sealed under argon atmosphere. The container was set to a planet ball mill P-7 manufactured by Fritsch Japan Co., Ltd., and 6.20 g of a yellow powder sulfide solid electrolyte material (Li/P/S glass) was obtained by performing mechanical milling at 25° C. and the number of rotations of 510 rpm for 20 hours.

Subsequently, 160 zirconia beads having the diameter of 5 mm were introduced to a zirconia 45 mL container (manufactured by Fritsch Japan Co., Ltd.), 9.0 g of an sulfide inorganic solid electrolyte (Li/P/S glass), 0.3 g of HSBR (DYNARON 1321P manufactured by JSR Corporation) as a binding material, and 15.0 g of toluene as a dispersion medium were added, the container was set to a planetary ball mill P-7 manufactured by Fritsch Japan Co., Ltd., and the wet dispersion was performed for 90 minutes at the rotation speed of 360 rpm, so as to obtain sulfide solid electrolyte particles PS1. The average particle diameter was 1.5 μm, and the accumulative 90% particle diameter was 2.5 μm.

Separately, 160 zirconia beads having the diameter of 5 mm were introduced to a zirconia 45 mL container (manufactured by Fritsch Japan Co., Ltd.), 9.0 g of an sulfide inorganic solid electrolyte (Li/P/S glass), 0.3 g of HSBR (DYNARON 1321P manufactured by JSR Corporation) as a binding material, and 15.0 g of toluene as a dispersion medium were added, the container was set to a planetary ball mill P-7 manufactured by Fritsch Japan Co., Ltd., and the wet dispersion was performed for 120 minutes at the rotation speed of 360 rpm, so as to obtain sulfide solid electrolyte particles PS2. The average particle diameter was 0.9 μm, and the accumulative 90% particle diameter was 1.5 μm.

The invention is described with reference to specific embodiments and drawings, but, unless described otherwise, it is clear that any details of the invention which are not particularly designated are not intended to limit the invention, and it is obvious that the embodiments are widely construed without departing from the spirit and the scope of the invention recited in the accompanying claims.

### EXPLANATION OF REFERENCES

1: negative electrode collector
2: negative electrode active substance layer
3: inorganic solid electrolyte layer
4: positive electrode active substance layer
5: positive electrode collector
6: operating position
10: all-solid-state secondary battery

What is claimed is:

1. A solid electrolyte composition comprising:
inorganic solid electrolyte particles exhibiting at least two peaks in accumulative particle size distribution which is measured with a dynamic light scattering-type particle diameter distribution measuring device.

2. The solid electrolyte composition according to claim 1,
wherein, among the two or more peaks, a peak (Pa) of a maximum particle diameter is in the particle diameter range of 2 μm to 0.4 μm and a peak (Pb) of a minimum particle diameter is in the range of 1.5 μm to 0.1 μm, and a relationship between the peak (Pa) of the maximum particle diameter and the peak (Pb) of the minimum particle diameter satisfies Expression (1) below.
0.05≦Pb/Pa≦0.75 (1)

3. The solid electrolyte composition according to claim 1,
wherein the inorganic solid electrolyte particles include inorganic solid electrolyte particles A having an average particle diameter (da) of 2 μm to 0.4 μm and inorganic solid electrolyte particles B having an average particle diameter (db) of 1.5 μm to 0.1 μm, and Expression (2) below is satisfied.
0.05≦db/da≦0.75 (2)

4. The solid electrolyte composition according to claim 1,
wherein, with respect to the accumulative particle size distribution measured with the dynamic light scattering-type particle diameter distribution measuring device, when respective peaks are assumed to follow log-normal distribution and the waveform is separated by a nonlinear least square method, an accumulative 90% particle diameter (Pa90) of a peak (Pa) of a maximum particle diameter is 3.4 μm to 0.7 μm, and an accumulative 90% particle diameter (Pb90) of a peak (Pb) of a minimum particle diameter is 2.5 μm to 0.2 μm.

5. The solid electrolyte composition according to claim 1,
wherein, with respect to the accumulative particle size distribution measured with the dynamic light scattering-type particle diameter distribution measuring device, when respective peaks are assumed to follow log-normal distribution and the waveform is separated by a nonlinear least square method, a ratio of an area (WPa) of a peak (Pa) of a maximum particle diameter and an area (WPb) of a peak (Pb) of a minimum particle diameter satisfies Expression (3) below.
0.01≦WPb/(WPa+WPb)≦0.8 (3)

6. The solid electrolyte composition according to claim 3,
wherein an addition amount (Wb) of the inorganic solid electrolyte particles B having an average particle diameter (db) of 1.5 μm to 0.1 μm is smaller than an addition amount (Wa) of the inorganic solid electrolyte particles A having the average particle diameter (da) of 2 μm to 0.4 μm, and a mass ratio thereof satisfies Expression (4) below.
0.01≦Wb/(Wa+Wb)≦0.8 (4)

7. The solid electrolyte composition according to claim 1,
wherein the inorganic solid electrolyte particles are oxide-based or sulfide-based inorganic solid electrolyte particles.

8. The solid electrolyte composition according to claim 1, further comprising:
a binder.

9. The solid electrolyte composition according to claim 1, further comprising:
a dispersion medium.

10. A method for manufacturing a solid electrolyte composition prepared by mixing inorganic solid electrolyte particles A and inorganic solid electrolyte particles B,
wherein the inorganic solid electrolyte particles A have an average particle diameter (da) of 2 μm to 0.4 μm,
wherein the inorganic solid electrolyte particles B have an average particle diameter (db) of 1.5 μm to 0.1 μm, and
wherein Expression (2) below is satisfied.
0.05≦db/da≦0.75 (2)

11. The method for manufacturing the solid electrolyte composition according to claim 10,
wherein the inorganic solid electrolyte particles A have an accumulative 90% particle diameter of 3.4 μm to 0.7 μm, and
wherein the inorganic solid electrolyte particles B have an accumulative 90% particle diameter of 2.5 μm to 0.2 μm.

12. The method for manufacturing the solid electrolyte composition according to claim 10,
wherein an addition amount (Wa) of the inorganic solid electrolyte particles A and an addition amount (Wb) of the inorganic solid electrolyte particles B satisfy Expression (4) below.
0.01≦Wb/(Wa+Wb)≦0.8 (4)

13. The method for manufacturing the solid electrolyte composition according to claim 10,
wherein the inorganic solid electrolyte particles A and the inorganic solid electrolyte particles B are treated at least by a wet dispersion method or a dry dispersion method, respectively, and the inorganic solid electrolyte particles A and the inorganic solid electrolyte particles B are mixed.

14. An electrode sheet for a battery comprising:
the solid electrolyte composition according to claim 1.

15. An all-solid-state secondary battery comprising:
the electrode sheet for a battery according to claim 14.
